(19) United States
(12) Patent Application Publication
(10) Pub. No.: US 2012/0036968 A1
(43) Pub. Date: Feb. 16, 2012

(54) RATCHET WRENCH WITH REVERSIBLE MECHANISM

(76) Inventor: Hong-Jen Lee, Taichung (TW)

(21) Appl. No.: 12/904,126

(22) Filed: Oct. 13, 2010

Related U.S. Application Data
(63) Continuation of application No. 12/853,298, filed on Aug. 10, 2010.

(51) Int. Cl. B25B 13/46

(52) U.S. Cl. 81/63.1

(57) ABSTRACT

The present invention discloses a ratchet wrench comprising a main body, a driving head, three pawls, a knurled rotatable disc and a locking ring. The driving head has a limit portion and a couple portion for coupling a workpiece. The limit portion has three tangent planes each forming a recess cut for pawl located. The limit portion has a cylinder linking with the locking ring. The limit portion is mounted by a mounting piece having three sliding slots and three rails. Each pawl is guided by a relative rail and has a rod linking to an elastic element. When the knurled rotatable disc is turned to interact the rod, the rod triggers the pawl, and the retaining cogs of the pawl are engaged with the ratchet teeth to control the driving head being turned clockwise or counterclockwise.

This application is a Continuation-in-Part of U.S. application Ser. No. 12/853,298, entitled “RATCHET WRENCH WITH REVERSIBLE MECHANISM”, naming Hong-Jen Lee as inventor, and filed on Aug. 10, 2010.

### FIELD OF THE INVENTION

### Background of the Invention

For a conventional ratchet wrench structure, such as U.S. Pat. No. 4,497,227, the lateral side of the driving head holds one or two pawls. The retaining teeth of the pawl engage with the ratchet teeth on the inner wall of the head portion of the main body, and an upper lid is disposed on the head portion, and connected with a spring. One end of the spring connects the pawl. The rotation of the upper lid controls the spring to rotate. Then, the spring pushes the pawl to swing and engage with the ratchet teeth of the head portion by retaining teeth on left side or right side, and further control the driving head having the ability of clockwise or counterclockwise drive.

However, the disadvantages of the above-mentioned US patent are as followings:

1. Controlling the ratchet wrench to make clockwise or counterclockwise turn relies on the upper lid to push the spring which makes the pawl to swing. During operation, the spring must bear a bigger reaction. It is easy to get elastic fatigue, and the retaining teeth of the pawl cannot properly engage with the ratchet teeth.

2. It is necessary to machine the upper lid to get a receiving chamber to hold the spring. However, the upper lid is not a circle. It requires milling. However, milling will increases the machining time and the cost of fabrication.

3. The actuation principle of the ratchet wrench requires a certain length of spring to fit an elastic action being produced when the retaining teeth of the pawl and the wretch gear are not relatively in mesh. The upper lid needs to receive a spring, and has a bigger diameter. Thus, the head portion of the wrench also needs a matching diameter. Therefore, one size of the upper lid and the pawl cannot fit different sizes of the wrench.

4. For assembling, if the two springs are firstly assembled with the pawl, and then the upper lid is assembled, it is not easy to align the two springs because the receiving chamber faces downward. It causes an assembling inconvenience.

There is another ratchet wrench disclosed in U.S. Pat. No. 6,769,330, whose operational end of the main body holds one driving head. The two lateral sides of the driving head hold two pawls. The retaining teeth of the pawl engage with the ratchet teeth on the inner wall of the main body. The two pawls are connected and positioned by two elastic elements. The advantage of the patent is that the elastic elements are wound around the periphery of the driving head. Thus, the elastic elements avoid the disadvantage that the spring mentioned in U.S. Pat. No. 4,497,127 occupies the space. However, the disadvantage of the aforementioned patent is: the elastic element is in form of wire, one end of the elastic element is disposed on the driving head and the other end is connected to the pawl, so that the ratchet wench is unable to make a clockwise or counterclockwise driving. In other words, the pawl cannot swing except one directional rotation. If the user wants to get another direction of rotation, he has to turn over the ratchet wrench to another side for use. Thus, the ratchet wrench of U.S. Pat. No. 6,769,330 is inconvenient in use.

Another prior art of a ratchet wrench disclosed in Taiwan Patent Application No. 096219094, the ratchet wrench is a hand tool that adopts a ratchet wheel as a driving device. On one side of the hand tool is an adjustable operation unit to be operated in accordance with its component-assembly, and on the other side is a driving unit which has a housing with ratchet teeth on its inner wall. There is a rotatable member located within the housing with a couple opening. The outer periphery of the rotatable member has a plurality of movable tangent planes equally arranged to be lain by limit members. At the outer portion of each limit member are retaining cogs relatively engaged with the ratchet teeth, and at the inner portion is a surface resting against a tangent plane of the rotatable member. There are two linkages extended from the top and the bottom of the limit member to link with both sides of the tangent plane respectively. Two annular cover pieces are applied on both sides of the housing to conceal the limit members and the rotatable member. Although the prior art has three sets of retaining cogs and, therefore, has stable rotary ability than the ratchet wrench with two sets of retaining cogs. Inasmuch as its linkage links the rotatable member at one side and the retaining cogs at the other side, it can only drive the cogs to move in single direction. If it requires to operate in the reverse direction, the wrench needs to be turned upside down. The disadvantage of the prior art is that it is inconvenient for users to operate the hand tool with single direction driving.

### SUMMARY OF THE INVENTION

The object of the present invention is to provide a ratchet wrench comprising three pawls, which are interacted for controlling its reversing mechanism, in order to evenly distribute the force exerted over the wrench. Generally described, a ratchet mechanism according to the present invention includes a main body, a driving head, three pawls, a knurled rotatable disc and a locking ring. The middle part of the driving head is a disc which has a polygonal columned couple portion extended from the bottom of the disc for a workpiece to be coupled and a columned limit portion extended from the top center of the disc. The periphery of the limit portion has three tangent planes with equal central angles. Each tangent plane and the top of the disc forms a recess cut, and each pawl is respectively located within a recess cut. When the knurled rotatable disc is turned against an annular head portion, it drives the pawls to be engaged with ratchet teeth. The limit portion has a cylinder penetrating the knurled rotatable disc to link with the locking ring. The limit portion is mounted by a mounting piece and the mounting piece has three first sliding slots and three rails bored on its top. Each pawl is guided by a relative rail and its top extends a rod upwards. Each rod is hooked by an elastic element which provides elasticity for the rod to move in radial direction. Therefore, the knurled rotatable disc is able to interact with the rod and to be turned against the limit portion. When the knurled rotatable disc is turned clockwise or counterclockwise, one side of each pawl or its retaining cogs on the other side are able to be engaged with the ratchet teeth by means of interaction between the rod and the pawl for the pawl to move laterally, clockwise or counterclockwise, along its relative rail and tangent plane.

### BRIEF DESCRIPTION OF THE DRAWINGS

FIG. 1 is an exploded view of the present invention;

FIG. 2 is a partial assembled view of the present invention;

FIG. 3 is a partial assembled schematic view of the present invention;

FIG. 4 is a top view of the present invention;

FIG. 5 is a cross-sectional view taken along lines A-A of FIG. 4;

FIG. 6 is a side view of the present invention;

FIG. 7 is a cross-sectional view taken along lines B-B of FIG. 6 showing pawls at one side;

FIG. 8 is a cross-sectional view taken along lines C-C of FIG. 6 showing the rotatable disc turning to a certain angle;

FIG. 9 is a cross-sectional view taken along lines B-B of FIG. 6 showing pawls at the other side; and

FIG. 10 is a cross-sectional view taken along lines C-C of FIG. 6 showing the rotatable disc turning to another angle.

### DETAILED DESCRIPTION OF THE PREFERRED EMBODIMENT

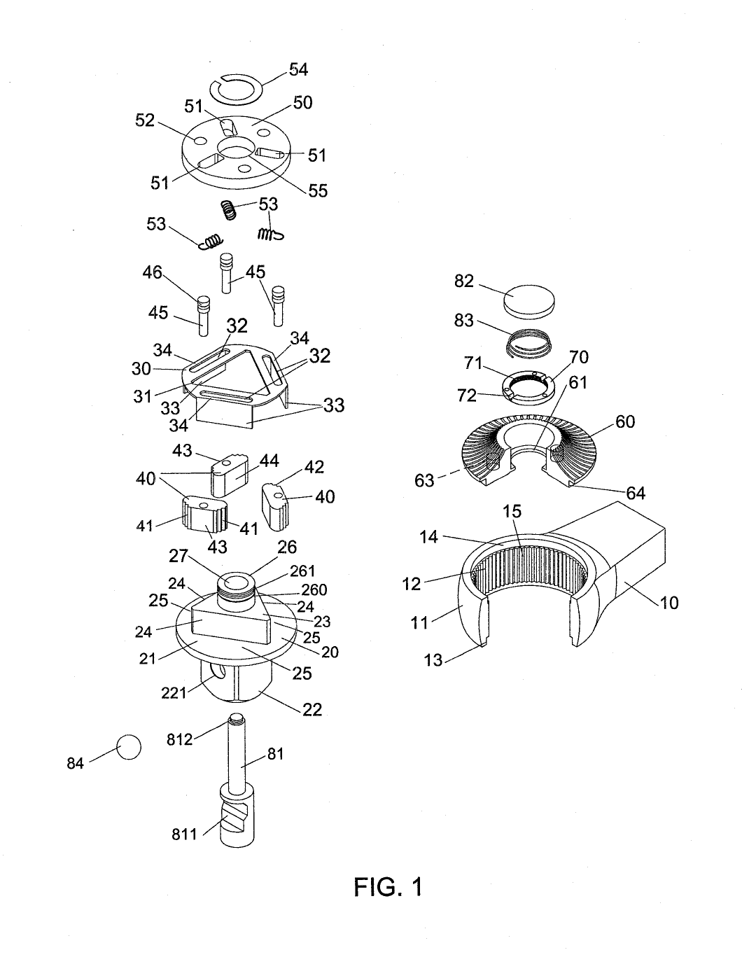

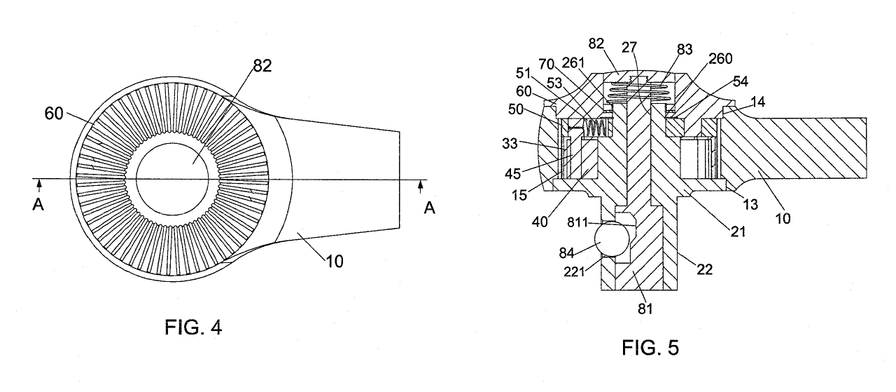

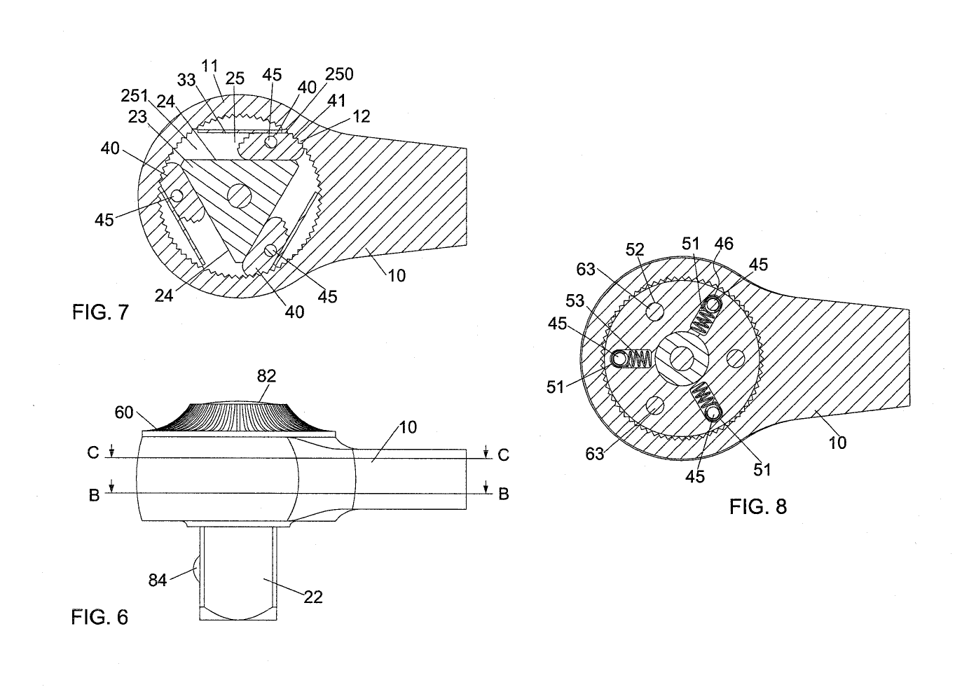

Referring to FIG. 1 to FIG. 10, in order to achieve the objects mentioned above, the basic structure of the ratchet wrench includes a main body 10, a driving head 20, three pawls 40, a knurled rotatable disc 60 and a locking ring 70. There is an annular head portion 11 vertically inserted in a circular housing 15, whose inner wall has a plurality of ratchet teeth 12, at one end of the main body 10. The driving head 20 is rotatably located within the circular housing 15, and its middle portion is a disc 21 which shares the same axis with the circular housing 15. The periphery of the disc 21 is engaged with the bottom of the circular housing 15. There is a polygonal columned couple portion 22 extended downwards from the center bottom of the disc 21 for a workpiece to be coupled, and there is also a columned limit portion 23 extended upwards from the top center of the disc 21. The periphery of the limit portion 23 has three tangent planes 24 with equal central angles against the center axis of the limit portion 23. Each tangent plane 24 and the top of the disc 21 form a recess cut 25, and each pawl 40 is respectively located within a recess cut 25. The knurled rotatable disc 60 is rotatably topped on the circular housing 15. When the knurled rotatable disc 60 is turned against the annular head portion 11, it drives the pawls 40 to be engaged with ratchet teeth 12. The top center of the limit portion 23 is an extruded cylinder 26 whose outer periphery has an annular groove 260 and an outer screw-thread section 261 to couple with a C-clip 54 and the inner screw-thread section 71 of the locking ring 70 respectively. The cylinder 26 and the disc 21 share the same axis. The extruded cylinder 26 penetrates through a cylinder duct 55 in the center of the rotatable disc 50, and its annular groove 260 is snapped by a C-clip 54 at the top of the rotatable disc 50 to limit the cylinder 26. Furthermore, the end portion of the cylinder 26 penetrates the knurled rotatable disc 60 through the first linkage duct 61, and the screw-thread section 261 is screwed by the locking ring 70 at the top of the knurled rotatable disc 60 to limit the cylinder 26.

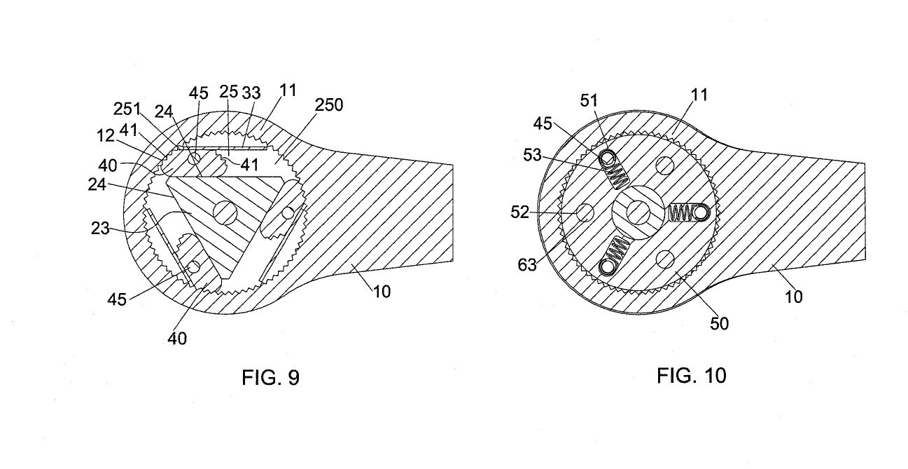

Features of the basic structure are: the limit portion 23 being mounted by a mounting piece 30 which also covers the top of the recess cut 25, three first sliding slots 32 and three rails 33 being arranged with equal central angles against the center axis of the mounting piece 30, each first sliding slot 32 being extended relative to a rail 33 in parallel and the direction to extend the rail 33 being in parallel with a tangent to the disc; each pawl 40 being guided by a relative rail 33 and having a front plane 43 and a back plane 44 opposite to each other, the front plane 43 having retaining cogs 41 on its two vertical sides and the back plane 44 being lain back against the tangent plane 24, each pawl 40 also extending a rod 45 upwards on its top, the middle portion of the rod 45 penetrating a relative first sliding slot 32 and its top portion linking to one end of an elastic element 53 which provides elasticity for the rod 45 to move in radial direction, therefore, the knurled rotatable disc 60 being able to interact with the rod 45 and to be turned against the limit portion 23; shown as FIG. 7 and FIG. 8, when the knurled rotatable disc 60 being turned clockwise to interact with the rod 45, the rod 45 triggering the pawl 40 to laterally move clockwise as well along the rail 33 and the tangent plane 24, and furthermore, the retaining cogs 41 on one side of the pawl 40 being engaged with the ratchet teeth 12; shown as FIG. 9 and FIG. 10, when the knurled rotatable disc 60 being turned counterclockwise, the pawl 40 laterally move counterclockwise as well along the rail 33 and the tangent plane 24 to the opposite direction and its retaining cogs 41 on the other side being engaged with the ratchet teeth 12 then.

Referring to FIG. 1, in one embodiment of the present invention, there is a rotatable disc 50 located on the top of the mounting piece 30 which mounted over the limit portion 23. The rotatable disc 50 and the mounting piece 30 share the same axis, and there are three second sliding slots 51 arranged with equal central angles against the center axis on the rotatable disc 50. The second sliding slot 51 is extended along the radial direction of the center axis of the rotatable disc 50, and each second sliding slot 51 is corresponding to one first sliding slot 32. The top portion of the rod 45 penetrates through one side of one relative second sliding slot 51 and hooks onto one end of the elastic element 53, and the other end of the elastic element 53 is against the inner wall of the other end of the second sliding slot 51. Wherein, on the rotatable disc 50 is at least one round trough 52, and on the bottom of the knurled rotatable disc 60 is at least one protrusion 63 which is inserted into the round trough 52 for the rotatable disc 50 and the knurled rotatable disc 60 to interlink together. Furthermore, at one end of the elastic element 53 is a loop 530 which is employed to snap in a groove 46 at the top portion of the rod 45.

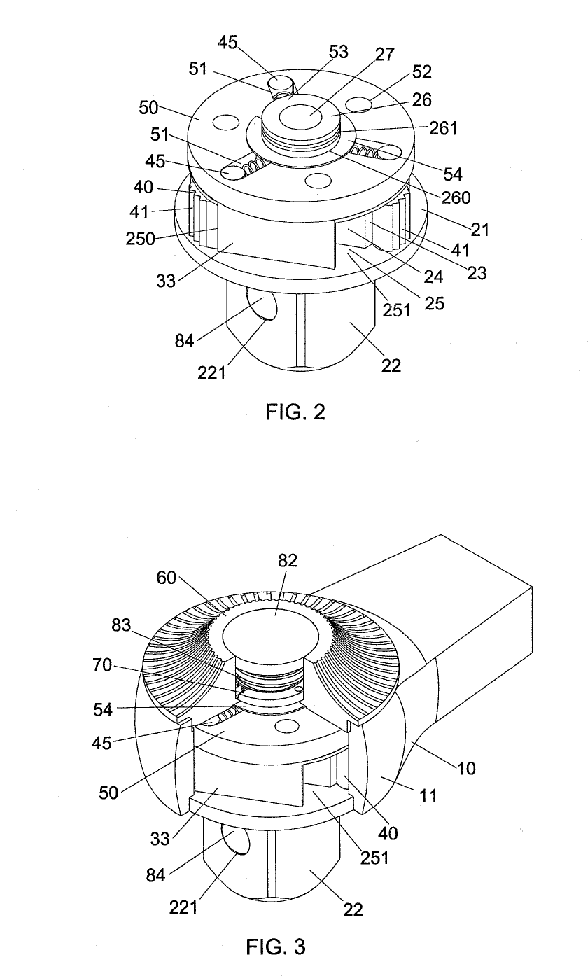

Referring to FIG. 1 and FIG. 2, in one of the embodiments of the present invention, the mounting piece 30 includes a mounting opening 31 at its center and three edge slabs 34 arranged with equal central angles against the center axis. The mounting opening 31 is mounted over the limit portion 23 to be fixed in position. Each first sliding slot 32 is allocated corresponding to an edge slab 34 and each rail 33 is extended downwards from the edge slab 34. Therefore, each recess cut 25 is embraced by the edge slab 34, the disc 21, the rail 33 and the tangent plane 24 as its top, bottom, front plane and back plane respectively. Meanwhile, two gaps 250/251 are formed at both vertical sides of the recess cut 25. The front plane 43 of each pawl 40 is lain against the rail 33. When the pawl 40 moves right side against the limit portion 23, the retaining cogs 41 reaches out of the gap 250 from the recess cut 25 to engage with the ratchet teeth 12. And when the pawl 40 moves left side against the limit portion 23, the retaining cogs 41 reaches out of the other gap 251 from the recess cut 25 to engage with the ratchet teeth 12. Wherein, four sides of each first sliding slot 32 are self-contained to form a long slot, and the bottom of each rail 33 rests on the top of the disc 21.

Referring to FIG. 1 and FIG. 5, there is a better embodiment of the present invention. A hollow duct 27 is bored downwards from the top center of the cylinder 26 and the limit portion 23, and a spheroid hole 221 is bored on the periphery of the couple portion 22 to communicate with the hollow duct 27. A control shaft 81 is vertically inserted through the hollow duct 27, and its outer periphery at the bottom portion has a spheroid trough 811 corresponding to the spheroid hole 221 in the couple portion 22.

The inner wall of the spheroid trough 811 is ladder-like. At the top portion of the control shaft 81 is a screw-thread section 812. Inasmuch as the control shaft 81 protrudes from the top of the hollow duct 27, the screw-thread section 812 exposes above the locking ring 70 and couples with the thread-couple element 82. There is a spring 83 applied between the thread-couple element 82 and the locking ring 70, and there is a spheroid 84 allocated between the spheroid hole 221 and the spheroid trough 811.

Referring to FIG. 1 and FIG. 7, in a better embodiment of the present invention, the limit portion 23 is designed as a triangular column with three tangent planes 24 in order to economize material cost and manufacture with convenience.

Referring to FIG. 1 and FIG. 2, in a better embodiment of the present invention, there are one first annular trough 14 and one second annular trough 13, which are extended outwards with diameters larger than the housing, on the top and the bottom of the circular housing 15 respectively. The first annular trough 14 allows the knurled rotatable disc 60 to be mounted and the second annular trough 13 provides a recess for the disc 21.

Referring to FIG. 1, in a preferable embodiment of the present invention, the top of the locking ring 70 is provided a transverse groove 72 thereon, the groove 72 is provided for the drill of a screwdriver to engage and drive.

While we have shown and described the embodiment in accordance with the present invention, it should be clear to those skilled in the art that further embodiments may be made without departing from the scope of the present invention.

1. A ratchet wrench comprising:
a main body with an annular head portion vertically inserted in a circular housing, whose inner wall has a plurality of ratchet teeth, at one end of the main body; a driving head rotatably located within the circular housing and its middle portion being a disc which shares the same axis with the circular housing, the periphery of the disc being engaged with the bottom of the circular housing, a polygonal columned couple portion extending downwards from the center bottom of the disc for a workpiece to be coupled, a columned limit portion also extending upwards from the top center of the disc, the periphery of the limit portion having a plurality of tangent planes with equal central angles, and each tangent plane and the top of the disc forming a recess cut;
a plurality of pawls being respectively located within a recess cut; and a knurled rotatable disc being rotatably topped on the circular housing, as the knurled rotatable disc being turned against the annular head portion, it driving the pawls to be engaged with ratchet teeth;
wherein:
the limit portion having three tangent planes and three recess cuts with equal central angles respectively, three pawls being respectively located within three recess cuts; the limit portion being mounted by a mounting piece which also covers the top of the recess cut, three first sliding slots and three rails being arranged with equal central angles against the center axis on the mounting piece, each first sliding slot being extended relative to a rail in parallel and the direction to extend the rail being in parallel with a tangent to the disc; each pawl being guided by a relative rail and having a front plane and a back plane opposite to each other, the front plane having retaining cogs on its two vertical sides and the back plane being lain back against the tangent plane; each pawl also extending a rod upwards on its top; a rotatable disc being located on the top of the mounting piece; three second sliding slots being arranged with equal central angles against the center axis on the rotatable disc, and being extended along the radial direction of the center axis of the rotatable disc and each second sliding slot corresponding to one first sliding slot; the middle portion of each rod penetrating one 10 relative first sliding slot, the top portion of each rod penetrating through one side of one relative second sliding slot and being connected by one end of an elastic element, and the other end of the elastic element being against the inner wall of the other end of the second sliding slot so as to provide elasticity for the rod to move along the second sliding slot; the rotatable disc and the knurled rotatable disc being interlinked together; the top center of the limit portion being an extruded cylinder whose outer periphery has an annular groove and an outer screw-thread section to couple with a C-clip and an inner screw-thread section of a locking ring respectively; the cylinder and the disc sharing the same axis, the extruded cylinder penetrating through a cylinder duct in the center of the rotatable disc, and its annular groove being snapped by a C-clip at the top of the rotatable disc to limit the cylinder, the end portion of the cylinder penetrating the knurled rotatable disc through a first linkage duct, and the screw-thread section being screwed by the locking ring at the top of the knurled rotatable disc to limit the cylinder; as the knurled rotatable disc being turned clockwise to interact with the rod, the rod triggering the pawl to laterally move clockwise as well along the rail and the tangent plane, and the retaining cogs on one side of the pawl being engaged with the ratchet teeth; and as the knurled rotatable disc being turned counterclockwise, the pawl laterally move counterclockwise as well along the rail and the tangent plane to the opposite direction and its retaining cogs on the other side being engaged with the ratchet teeth.

2. The ratchet wrench as claimed in claim 1, wherein on the rotatable disc is at least one round trough, and on the bottom of the knurled rotatable disc is at least one protrusion which is inserted into the round trough for the rotatable disc and the knurled rotatable disc to interlink together.

3. The ratchet wrench as claimed in claim 1, wherein the mounting piece includes a mounting opening at its center and three edge slabs arranged with equal central angles against the center axis; the mounting opening is mounted over the limit portion to be fixed in position; each first sliding slot is allocated corresponding to an edge slab and each rail is extended downwards from the edge slab, the bottom of each rail resting on the top of the disc of the driving head; each recess cut is embraced by the edge slab, the disc, the rail and the tangent plane as its top, bottom, front plane and back plane respectively; two gaps are formed at both vertical sides of the recess cut and the front plane of each pawl is lain against the rail; as the pawl moves clockwise, the retaining cogs reaches out of the gap from the recess cut to engage with the ratchet teeth; and as the pawl moves counterclockwise, the retaining cogs reaches out of the other gap from the recess cut to engage with the ratchet teeth.

4. The ratchet wrench as claimed in claim 1, wherein a hollow duct is bored downwards from the top center of the limit portion and a spheroid hole is bored on the periphery of the couple portion to communicate with the hollow duct; a control shaft is vertically inserted through the hollow duct and its outer periphery at the bottom portion has a spheroid trough corresponding to the spheroid hole in the couple portion; the inner wall of the spheroid trough is ladder-like and at the top portion of the control shaft is a screw-thread section; inasmuch as the control shaft protrudes from the top of the hollow duct, the screw-thread section of the control shaft, exposes above the locking ring and couples with the thread-couple element; there is a spring applied between the thread-couple element and the locking ring, and there is a spheroid allocated between the spheroid hole and the spheroid trough.

5. The ratchet wrench as claimed in claim 1, wherein the limit portion is designed as a triangular column with three tangent planes.

6. The ratchet wrench as claimed in claim 1, wherein at one end of the elastic element is a loop which is employed to snap in a groove at the top portion of the rod.

7. The ratchet wrench as claimed in claim 1, wherein there is a first annular trough extended outwards with a diameter larger than the housing on the top of the circular housing for the knurled rotatable disc to be mounted.

8. The ratchet wrench as claimed in claim 1, wherein there is a second annular trough extended outwards with a diameter larger than the housing on the bottom of the circular housing for the disc to be mounted.

9. The ratchet wrench as claimed in claim 1, wherein the top of the locking ring is provided a transverse groove thereon for the drill of a screwdriver to engage and drive.
